(19) United States
(12) Patent Application Publication
(10) Pub. No.: US 2024/0156240 A1
(43) Pub. Date: May 16, 2024

(54) END PIECE FOR A PERSONAL HYDRATION SYSTEM

(71) Applicant: OUVRY, Lyon (FR)

(72) Inventors: Thierry POLLET, Lyon (FR); Carole DOUGNAC, Lyon (FR); Julie MERCIER, Lyon (FR)

(73) Assignee: OUVRY, Lyon (FR)

(21) Appl. No.: 18/281,387

(22) PCT Filed: Mar. 4, 2022
(86) PCT No.: PCT/EP2022/055640

§ 371 Date: Sep. 11, 2023

(30) Foreign Application Priority Data
Mar. 12, 2021 (FR) FR2102496

(51) Int. Cl. A45F 3/16

(52) U.S. Cl. CPC A45F 3/16; A45F 2003/166

(57) ABSTRACT

An end piece for a personal hydration system including a mechanism for storing a liquid, the end piece with a mechanism for conveying a liquid, and a selection second mechanism for configuring the end piece in a position chosen from among a closed position in which the liquid conveying mechanism are blocked, a first position in which the liquid passes through the conveying mechanism and a second position in which the conveying mechanism are connected to a docking mechanism connected to a protective mask and in which the liquid passes through the conveying mechanism and the protective mask docking mechanism.

The present invention relates to an end piece for a personal hydration system and to a personal hydration system comprising an end piece.

It is known to use personal hydration systems which allow users to drink while still participating in physical sporting or recreational activities. These personal hydration systems generally have a fluid reservoir in the form of a pouch which is carried in a bag mounted on the back or on the waist. One end of a flexible tube is connected to the reservoir by an outlet orifice and another end of the flexible tube is connected to an end piece. The tube allows the end piece to be carried in the user's mouth in order to allow the user to take in water from the reservoir as desired.

Although personal hydration systems have proven to be a major development over traditional water cans, they have some drawbacks. One of the drawbacks of current end pieces is that they are systems which are complex to manufacture and use. This is because some current hydration systems are configured for use during an application, such as a sporting, recreational or military activity. Within the context of military use in a Chemical, Biological, Radiological and Nuclear (CBRN) configuration, these hydration systems require the end piece to be modified in order to connect it to CBRN protective masks.

An aim of the invention is to overcome the drawbacks mentioned by proposing notably a single end piece for a personal hydration system which is versatile, ergonomic, easy to use and can be adapted easily to various activities in non-CBRN and CBRN environments, that is to say with or without the wearing of a CBRN respiratory protection mask.

The present invention relates to an end piece for a personal hydration system including a liquid storage means, said end piece comprising:
means for conveying a liquid,
selection means for configuring the end piece in a position chosen from:
   a closed position in which the liquid conveying means are blocked,
   a first position in which the liquid passes through the conveying means to enable direct oral hydration, and
   a second position in which the conveying means are connected to docking means connected to a protective mask and in which the liquid passes through the conveying means and the docking means of the protective mask to enable oral hydration via the protective mask;
   wherein the liquid conveying means comprise a central cylindrical body surmounted by an arm disposed perpendicularly to the central cylindrical body, said arm comprising a first end connected to a nipple and a second end connected to the docking means of the protective mask;
   and wherein the end piece comprises a three-way valve.

The end piece for a personal hydration system according to the invention is singular, ergonomic, easy to implement for the user and does not need any change to be adapted to various applications. The end piece is configured so as to enable the intake of liquid directly via the oral route or via a connection to a protective mask. A single end piece is thus used for two separate applications.

In one embodiment, the liquid conveying means comprise an external cylindrical body, a central cylindrical body, an internal cylindrical body, a movable flap and an elastic element, the internal cylindrical body being disposed in the central cylindrical body, the external cylindrical body interacting with the central cylindrical body, the movable flap being disposed in the internal cylindrical body, said movable flap being connected to the elastic element. In this embodiment, the external cylindrical body, the central cylindrical body, the internal cylindrical body, the movable flap and the elastic element interact such that the end piece can reach a position chosen from the closed position, the first position and the second position.

In one embodiment, the elastic element is a spring.

In one embodiment, the central cylindrical body and the internal cylindrical body comprise an upper face including an opening in which an upper face of the movable flap can engage. In this embodiment, the upper face of the movable flap is disposed so as to block the liquid conveying means, that is to say the central cylindrical body and the internal cylindrical body are positioned in the closed position and do not allow the liquid to reach the conveying means. Furthermore, it is possible to unlock and pull solely the central cylindrical body (first position). Lastly, a connection to the docking means of the protective mask is possible such that the liquid passes through the conveying means and the docking means of the protective mask by exerting a pressure on the movable flap such that the movable flap and the elastic element are retracted (second position).

In one embodiment, when the end piece is configured in the second position, the flap and the elastic element act as a self-closing system. In this embodiment, if the docking means are disconnected voluntarily or involuntarily from the conveying means, the elastic element moves from a retracted position to an extended position such that the upper face of the movable flap engages in the upper faces of the central cylindrical body and the internal cylindrical body and thus blocks the supply of liquid.

In one embodiment, the central cylindrical body is movable. For example, the central cylindrical body slides along the external cylindrical body.

In one embodiment, the external cylindrical body comprises an upper face including an opening through which the central cylindrical body passes.

In one embodiment, the central cylindrical body comprises radial rotation means intended to turn in grooves located in the external cylindrical body. In this embodiment, the radial rotation means turn easily in the grooves located in the external cylindrical body such that the closed position or the first position is reached by way of a vertical movement of the central cylindrical body.

Preferably, the radial rotation means are bayonet mounts.

In another embodiment, the central cylindrical body comprises friction means for vertically moving it.

In one embodiment, the central cylindrical body is a nipple, for example an anti-drip nipple. In particular, the central cylindrical body behaves like a nipple when the end piece is configured in the first position.

For this, the external cylindrical body, the central cylindrical body, the internal cylindrical body and the movable flap are made of polymer.

Preferably, the external cylindrical body, the central cylindrical body, the internal cylindrical body and the movable flap are suitable for contact with food. They thus satisfy regulatory or normative requirements, ensuring there is no risk of toxicity caused by the release of toxins linked to the polymers into the liquids.

In one embodiment, the external cylindrical body, the central cylindrical body, the internal cylindrical body and the movable flap are anti-allergenic.

In one embodiment, the docking means of the protective mask are connected to a pipette disposed in the protective mask. In particular, when the end piece is configured in the second position, it is connected to a protective mask.

For example, in the closed position, the upper face of the central cylindrical body, the upper face of the internal cylindrical body and the upper face of the movable flap are aligned such that the liquid cannot escape from the end piece.

For example, to ensure an intake of liquid directly into a user's mouth, the user can turn or pull the central cylindrical body, causing rotation of the radial rotation means, in the grooves of the external cylindrical body, or a translational movement from the closed position to the first position. The user can then take in the liquid directly into their mouth.

For example, to ensure an intake of liquid via the protective mask, from the closed position to the second position, the user can exert a pressure on the movable flap such that the elastic element and the movable flap are retracted. The docking means can then be connected to the movable flap such that the liquid passes through the docking means of the protective mask that are connected to a pipette which is located in the protective mask. The user can then take in the liquid via the pipette of the protective mask.

To ensure an intake of liquid via the protective mask, from the first position to the second position, the user can turn or push the central cylindrical body, causing rotation of the radial rotation means in the grooves of the external cylindrical body or a translational movement from the first position to the closed position. The docking means can then be connected to the movable flap such that the liquid passes through the docking means of the protective mask that are connected to a pipette which is located in the protective mask. The user can then take in the liquid via the pipette of the protective mask.

For example, to lock the end piece in place in the closed position from the first position, all the user then needs to do is push or rotate the central cylindrical body toward the external cylindrical body. This locks the end piece in place and ensures leaktightness.

For example, to lock the end piece in place in the closed position from the second position, all that then needs to be done is withdraw the docking means such that the elastic element moves from a retracted position to an extended position such that the upper face of the movable flap engages in the upper faces of the central cylindrical body and the internal cylindrical body and thus blocks the supply of liquid. In this example, the movable flap and the elastic element act as a self-closing system. This locks the end piece in place and ensures leaktightness.

In one embodiment, the liquid conveying means comprise a central cylindrical body surmounted by an arm disposed perpendicularly to the central cylindrical body, said arm comprising a first end connected to a nipple and a second end connected to the docking means of the protective mask. In this embodiment, the central cylindrical body and the arm interact such that the end piece can reach a position chosen from the closed position, the first position and the second position.

In one embodiment, the end piece comprises a three-way valve. In this embodiment, the three-way valve can then turn so as to block the liquid conveying means, that is to say the first and second ends of the arm (closed position); sous to allow the liquid to pass through the conveying means to reach the nipple, that is to say to block solely the second end of the arm (first position); or so as to enable a connection to the docking means of the protective mask and to allow the liquid to pass through the conveying means and the docking means of the protective mask, that is to say to block solely the first end of the arm (second position).

In one embodiment, the three-way valve comprises a pivot about which it turns in order to select one of said positions.

In one embodiment, the end piece comprises a movable flap and an elastic element. The movable flap and the elastic element act as a self-closing system. Preferably, the movable flap and the elastic element are disposed in the second end of the arm of the conveying means. In this embodiment, when the docking means are connected to the second end of the arm, the elastic element is in the retracted position such that the liquid passes through the conveying means of the end piece and the docking means of the protective mask. Furthermore, if the docking means of the protective mask are disconnected involuntarily from the second end of the arm, the elastic element moves from a retracted position to an extended position such that the movable flap closes off the second end of the arm. As a result, the supply of liquid is blocked.

In one embodiment, the cylindrical body, the arm and the nipple are made of polymer.

Preferably, the cylindrical body, the arm and the nipple are suitable for contact with food. They thus satisfy regulatory or normative requirements, ensuring there is no risk of toxicity caused by the release of toxins linked to the polymers into the liquids.

In one embodiment, the cylindrical body, the arm and the nipple are anti-allergenic.

The present invention also relates to a personal hydration system comprising an end piece according to the invention and a liquid storage means.

In one embodiment, the end piece comprises an adapter disposed between the liquid conveying means and the docking means of the protective mask. In this embodiment, the adapter is therefore disposed on the end piece, that is to say instead of the docking means of the protective mask. The end piece has the advantage of being adaptable to any type of mask irrespective of the design of the docking means of the protective mask. As a result, a single end piece can be connected to an infinite variety of protective masks.

In one embodiment, the adapter comprises a first end configured to be connected to the liquid conveying means and a second end configured to be connected to the docking means of the protective mask.

In one embodiment, the first or the second end of the adapter is a male element intended to engage in the liquid conveying means or in the docking means of the protective mask, which form a female element.

In one embodiment, the first or the second end of the adapter is a female element intended to receive the liquid conveying means or the docking means of the protective mask, which form a male element.

In particular, in one embodiment, the liquid conveying means forming a male or female element comprise an external cylindrical body, a central cylindrical body, an internal cylindrical body, a movable flap and an elastic element.

In particular, in one embodiment, the liquid conveying means forming a male or female element comprise the second end of the arm surmounting the central cylindrical body.

For example, the adapter has a tubular shape.

In one embodiment, the system comprises a liquid supply tube. In this embodiment, the supply tube is connected to the conveying means of the end piece.

For example, the protective mask comprises docking means connected to an end piece according to the invention or to an end piece of the hydration system.

In one embodiment, the docking means of the protective mask are connected to a pipette disposed in the protective mask. As a result, the user can still be supplied with liquid while wearing the protective mask.

In one embodiment, the protective mask is a CBRN mask.

The invention will be understood better by virtue of the following description, which relates to one or more embodiments according to the present invention and is given by way of non-limiting examples explained with reference to the appended schematic drawings, in which:

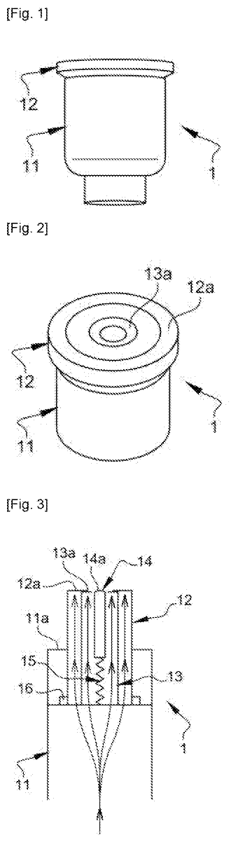

FIG. 1 is a side view of an example of an end piece for a hydration system according to the invention in the closed position,

FIG. 2 is an overview of an end piece for a hydration system according to the invention in the closed position,

FIG. 3 is a schematic view, in section, of an end piece for a hydration system according to the invention in the closed position,

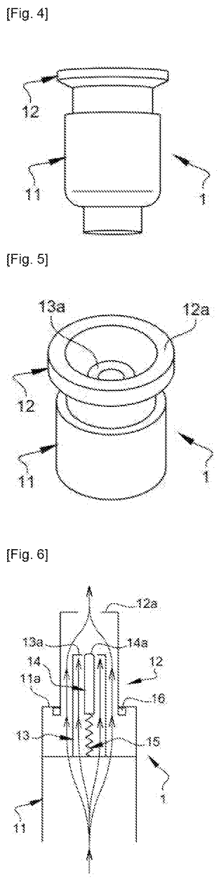

FIG. 4 is a side view of an end piece for a hydration system according to the invention, said end piece being configured in the first position,

FIG. 5 is an overview of an end piece for a hydration system according to the invention, said end piece being configured in the first position,

FIG. 6 is a schematic view, in section, of an end piece for a hydration system according to the invention, said end piece being configured in the first position,

FIG. 7 is a side view of an end piece for a hydration system according to the invention, said end piece being configured in the second position,

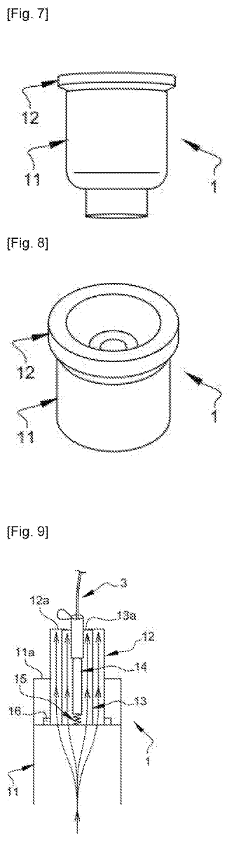

FIG. 8 is an overview of an end piece for a hydration system according to the invention, said end piece being configured in the second position,

FIG. 9 is a schematic view, in section, of an end piece for a hydration system, said end piece being configured in the second position according to the invention,

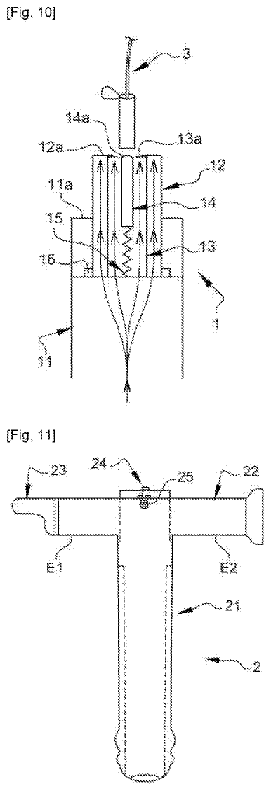

FIG. 10 is a schematic view, in section, of an end piece for a hydration system according to the invention, said end piece being separated from the docking means of a protective mask, the movable flap and the elastic element acting as a self-closing system,

FIG. 11 is an overview of an example of an end piece for a hydration system according to the invention,

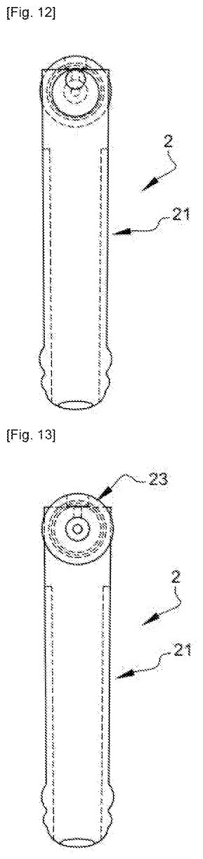

FIG. 12 is a side view of an end piece for a hydration system according to the invention,

FIG. 13 is another side view of an end piece for a hydration system according to the invention,

FIG. 14 is a view from above of an end piece for a hydration system according to the invention,

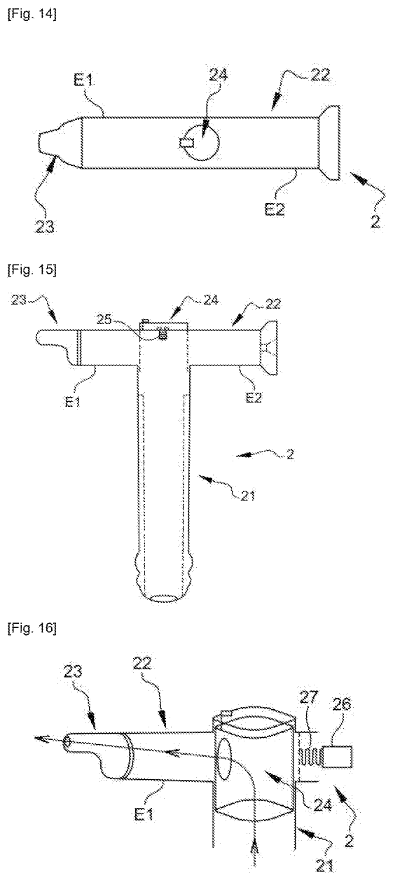

FIG. 15 is an example of an end piece for a hydration system according to the invention, said end piece being configured in the first position,

FIG. 16 is a view, in section, of an end piece for a hydration system according to the invention, said end piece being configured in the first position,

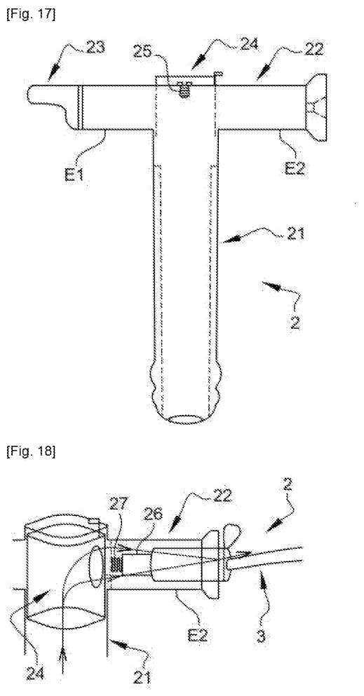

FIG. 17 is an example of an end piece for a hydration system according to the invention, said end piece being configured in the second position,

FIG. 18 is a schematic view, in section, of an example of an end piece for a hydration system according to the invention comprising a self-closing system, said end piece being configured in the second position, and

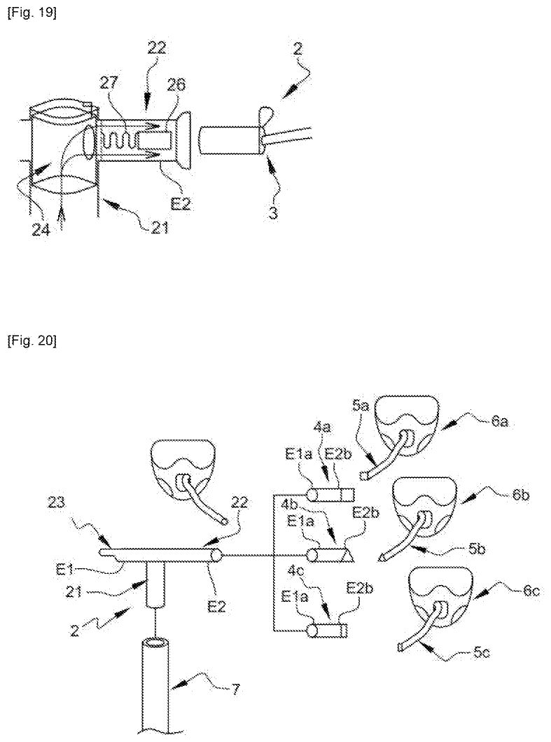

FIG. 19 is a schematic view, in section, of an example of an end piece for a hydration system according to the invention comprising a self-closing system, said end piece being separated from the docking means of a protective mask and being configured in the second position according to the invention, and

FIG. 20 is a schematic view of various examples of adapters connecting an end piece and a protective mask according to the invention.

FIGS. 1 to 19 illustrate an end piece 1, 2 for a personal hydration system (not illustrated) including a liquid storage means (not illustrated). The end piece 1, 2 comprises liquid conveying means and selection means for configuring the end piece in a position chosen from:
a closed position in which the liquid conveying means are blocked,
a first position in which the liquid passes through the conveying means to enable direct oral hydration, and
a second position in which the conveying means are connected to docking means 3 disposed on a protective mask (not illustrated) and in which the liquid passes through the conveying means and the docking means 3 of the protective mask to enable oral hydration via the protective mask.

FIGS. 1 to 10 illustrate an example of an end piece 1 in which the liquid conveying means comprise an external cylindrical body 11, a central cylindrical body 12, an internal cylindrical body 13, a movable flap 14 and an elastic element 15, the internal cylindrical body 13 being disposed in the central cylindrical body 12, the external cylindrical body 11 interacting with the central cylindrical body 12, the movable flap 14 being disposed in the internal cylindrical body 13, said movable flap 14 being connected to the elastic element 15. The external cylindrical body 11, the central cylindrical body 12, the external cylindrical body 11, the movable flap 14 and the elastic element 15 interact such that the end piece 1 can reach a position chosen from the closed position, the first position and the second position. The elastic element 15 may be, for example, a spring.

As is apparent in FIGS. 1 to 10, the central cylindrical body 12 and the internal cylindrical body 13 comprise an upper face 12a, 13a including an opening in which an upper face 14a of the movable flap 14 can engage. The upper face 14a of the movable flap 14 is disposed so as to block the liquid conveying means, that is to say the central cylindrical body 12 and the internal cylindrical body 13 (closed position, FIGS. 1-3 and 10); so as to allow the liquid to pass through the conveying means to reach the central cylindrical body 12, that is to say to unlock and pull solely the central cylindrical body 12 (first position, FIGS. 4-6); or so as to allow connection to the docking means 3 of the protective mask (second position) and to allow the liquid to pass through the conveying means and the docking means 2 of the protective mask, that is to say to exert a pressure on the movable flap 14 such that the movable flap 14 and the elastic element 15 are retracted (second position, FIGS. 7-9).

When the end piece 1 is configured in the second position, the movable flap 14 and the elastic element 15 act as a self-closing system. Thus, if the docking means 3 are disconnected involuntarily from the conveying means, the elastic element 15 moves from a retracted position to an extended position such that the upper face 14a of the movable flap 14 engages in the upper faces 12a, 13a of the central cylindrical body 12 and the internal cylindrical body 13 and thus blocks the supply of liquid (FIG. 10).

The central cylindrical body 12 is movable. The central cylindrical body 12 thus slides along the external cylindrical body 11.

The external cylindrical body 11 comprises an upper face 11a including an opening through which the central cylindrical body 12 passes.

The central cylindrical body 12 comprises radial rotation means or friction means such as vertical translational movement means 16 that are intended to turn or move in translation in grooves located in the external cylindrical body 11. The radial rotation or vertical translational movement means 16 may easily rise and fall in the grooves located in the external cylindrical body 11 so as to reach the closed position or the first position. Preferably, the radial rotation or vertical translational movement means 16 are bayonet mounts.

The central cylindrical body 12 takes the form of a nipple, for example an anti-drip nipple, via which a liquid can be delivered directly into a user's mouth. In particular, the central cylindrical body 12 is a nipple when the end piece 1 is configured in the first position.

For example, the external cylindrical body 11, the central cylindrical body 12, the internal cylindrical body 13 and the movable flap 14 are made of polymer.

Preferably, the external cylindrical body 11, the central cylindrical body 12, the internal cylindrical body 13 and the movable flap 14 are suitable for contact with food.

For example, the external cylindrical body 11, the central cylindrical body 12, the internal cylindrical body 13 and the movable flap 14 are anti-allergenic.

When the end piece 1 is configured in the second position, it is connected to a protective mask. The docking means 3 of the protective mask are then connected to a pipette (not illustrated) disposed in the protective mask.

FIGS. 1-3 illustrate an example of the closed position. For example, the upper face 12a of the central cylindrical body 12, the upper face 13a of the internal cylindrical body 13 and the upper face 14a of the movable flap 14 are aligned such that the liquid cannot escape from the end piece 1.

FIGS. 4-6 illustrate an example of the first position. For example, to ensure an intake of liquid directly into a user's mouth, the user can turn or pull the central cylindrical body 12, causing rotation of the radial rotation means 16, in the grooves of the external cylindrical body 11 or a translational movement from the closed position to the first position. The user can then take in the liquid directly into their mouth.

FIGS. 7-9 illustrate an example of the second position. To ensure an intake of liquid via the protective mask, from the closed position to the second position, the user can exert a pressure on the movable flap 14 such that the elastic element 15 and the movable flap 14 are retracted. The docking means 3 can then be connected to the movable flap 14 such that the liquid passes through the docking means 3 of the protective mask that are connected to a pipette which is located in the protective mask. The user can then take in the liquid via the pipette (not illustrated) of the protective mask.

To ensure an intake of liquid via the protective mask, from the first position to the second position, the user turns or pulls the central cylindrical body 12, causing rotation of the radial rotation means 16 in the grooves of the external cylindrical body 11 or a translational movement from the first position to the second position. The docking means 3 can then be connected to the movable flap 14 such that the liquid passes through the docking means 3 of the protective mask that are connected to a pipette which is located in the protective mask. The user can then take in the liquid via the pipette of the protective mask.

To lock the end piece in place in the closed position from the first position, all the user then needs to do is push the central cylindrical body 12 toward the external cylindrical body 11 or rotate the central cylindrical body 12 such that the radial rotation means 16 return to the closed position. This locks the end piece 1 in place and ensures leaktightness.

To lock the end piece in place in the closed position from the second position, all that then needs to be done is withdraw the docking means 3 such that the elastic element 15 moves from a retracted position to an extended position such that the upper face 14a of the movable flap 14 engages in the upper faces 12a, 13a of the central cylindrical body 12 and the internal cylindrical body 13 and thus blocks the supply of liquid. In this example, the movable flap 14 and the elastic element 15 act as a self-closing system (FIG. 10). This locks the end piece 1 in place and ensures leaktightness.

FIGS. 11-19 illustrate another example of an end piece 2, in which the liquid conveying means comprise a central cylindrical body 21 surmounted by an arm 22 disposed perpendicularly to the central cylindrical body 21, said arm 22 comprising a first end E1 connected to a nipple 23 and a second end E2 connected to the docking means 3 of the protective mask (not illustrated). The central cylindrical body 21 and the arm 22 interact such that the end piece 2 can reach a position chosen from the closed position, the first position and the second position.

The end piece 2 comprises a three-way valve 24. The three-way valve 24 can then turn so as to block the liquid conveying means, that is to say the ends E1, E2 of the arm 22 (closed position, FIG. 11); so as to allow the liquid to pass through the conveying means to reach the nipple 23, that is to say to block solely the second end E2 of the arm (first position, FIGS. 15-16); or so as to enable a connection to the docking means 3 of the protective mask and to allow the liquid to pass through the conveying means and the docking means 3 of the protective mask, that is to say to block solely the first end E1 of the arm (second position, FIGS. 17-18).

For example, the three-way valve 24 comprises a pivot 25 about which it turns in order to select one of said positions.

For example, the end piece 2 comprises a movable flap 26 and an elastic element 27. The movable flap 26 and the elastic element 27 act as a self-closing system. Preferably, the movable flap 26 and the elastic element 27 are disposed in the second end E2 of the arm 22 of the conveying means. As a result, when the docking means 3 are connected to the second end E2 of the arm 22, the elastic element 27 is in the retracted position such that the liquid passes through the conveying means of the end piece 2 and the docking means 3 of the protective mask. Furthermore, if the docking means 3 of the protective mask are disconnected voluntarily or involuntarily from the second end E2 of the arm 22, the elastic element 27 moves from a retracted position to an extended position such that the movable flap 26 closes off the second end E2 of the arm 22. As a result, the supply of liquid is blocked. The elastic element 27 is, for example, a spring (FIGS. 18 and 19).

Preferably, the cylindrical body 21, the nipple 23 and the arm 22 are made of polymer.

Preferably, the cylindrical body 21, the nipple 23 and the arm 22 are suitable for contact with food.

Preferably, the cylindrical body 21, the nipple 23 and the arm 22 are anti-allergenic.

FIG. 20 illustrates the end piece 2, in which the liquid conveying means comprise a central cylindrical body 21 surmounted by an arm 22 disposed perpendicularly to the central cylindrical body 21, said arm 22 comprising a first end E1 connected to a nipple 23 and a second end E2. The cylindrical body 21 is for example connected to the liquid supply tube 7.

In this example, the end piece 2 may comprise a tubular adapter chosen from the adapters 4a, 4b, 4c illustrated schematically in FIG. 20. The adapter 4a, 4b, 4c chosen is configured to be disposed between the liquid conveying means and the docking means 5a, 5b, 5c of a protective mask 6a, 6b, 6c.

The adapter 4a, 4b, 4c may comprise a first end Ela configured to be connected to the liquid conveying means and a second end E2a configured to be connected to the docking means 5a, 5b, 5c of a protective mask 6a, 6b, 6c.

For example, the first end Ela or the second end E2a of the adapter is a male element intended to engage in the liquid conveying means or in the docking means 5a, 5b, 5c of a protective mask 6a. 6b, 6c, which form a female element.

For example, the first end Ela or the second end E2a of the adapter is a female element intended to receive the liquid conveying means or the docking means 5a, 5b, 5c of a protective mask 6a, 6b, 6c, which form a male element.

The male and female elements are shown in FIG. 20 by identical symbols notably including a circle, a triangle, a rectangle and a square.

In this example, the liquid conveying means forming a male or female element comprise the second end E2 of the arm 22 surmounting the central cylindrical body 21.

The personal hydration system (not illustrated) comprises an end piece 1, 2 according to the invention and a liquid storage means (not illustrated). The hydration system also comprises a liquid supply tube 7 (FIG. 20) which is connected to the conveying means of the end piece 1, 2.

For example, the protective mask (not illustrated) comprises docking means 3 connected to an end piece 1, 2 according to the invention or to an end piece 1, 2 of the hydration system according to the invention.

For example, the docking means 3 of the protective mask are connected to a pipette (not illustrated) disposed in the protective mask. As a result, the user can still be supplied with liquid while wearing the CBRN protective mask. The end piece according to the invention may be easily used in various applications without the user needing to have an additional connection element. Furthermore, the optimized end piece is ergonomic and easy to implement for the user.

1. An end piece for a personal hydration system including a liquid storage means, said end piece comprising:
means for conveying a liquid,
selection means for configuring the end piece in a position chosen from:
a closed position in which the liquid conveying means are blocked,
a first position in which the liquid passes through the conveying means to enable direct oral hydration, and
a second position in which the conveying means are connected to docking means connected to a protective mask and in which the liquid passes through the conveying means and the docking means of the protective mask to enable oral hydration via the protective mask;
wherein the liquid conveying means comprise a central cylindrical body surmounted by an arm disposed perpendicularly to the central cylindrical body, said arm comprising a first end connected to a nipple and a second end connected to the docking means of the protective mask;
and wherein the end piece comprises a three-way valve.

2. An end piece for a personal hydration system including a liquid storage means, said end piece comprising:
means for conveying a liquid,
selection means for configuring the end piece in a position chosen from:
a closed position in which the liquid conveying means are blocked,
a first position in which the liquid passes through the conveying means to enable direct oral hydration, and
a second position in which the conveying means are connected to docking means connected to a protective mask and in which the liquid passes through the conveying means and the docking means of the protective mask to enable oral hydration via the protective mask;
wherein:
the liquid conveying means comprise an external cylindrical body, a central cylindrical body, an internal cylindrical body, a movable flap and an elastic element, the internal cylindrical body being disposed in the central cylindrical body, the external cylindrical body interacting with the central cylindrical body, the movable flap being disposed in the internal cylindrical body, said movable flap being connected to the elastic element;
the central cylindrical body and the internal cylindrical body comprise an upper face including an opening in which an upper face of the movable flap can engage;
the central cylindrical body is movable; and
the external cylindrical body comprises an upper face including an opening through which the central cylindrical body passes.

3. The end piece for a personal hydration system as claimed in claim 2, wherein the central cylindrical body comprises radial rotation means intended to turn in grooves located in the external cylindrical body.

4. The end piece for a personal hydration system as claimed in claim 2, wherein the central cylindrical body comprises friction means.

5. The end piece for a personal hydration system as claimed in claim 2, wherein the central cylindrical body is a nipple.

6. The end piece for a personal hydration system as claimed in claim 1, wherein the end piece comprises a movable flap and an elastic element.

7. The end piece for a personal hydration system as claimed in claim 6, wherein the movable flap and the elastic element are disposed in the second end of the arm of the conveying means.

8. The end piece for a personal hydration system as claimed in claim 1, wherein the docking means of the protective mask are connected to a pipette disposed in the protective mask.

9. The end piece for a personal hydration system as claimed in claim 1, wherein the end piece comprises an adapter disposed between the liquid conveying means and the docking means of the protective mask.

10. A personal hydration system comprising an end piece as claimed in claim 1, and a liquid storage means.

11. The hydration system as claimed in claim 10, wherein the system comprises a liquid supply tube.

12. The hydration system as claimed in claim 10, comprising an end piece having a movable flap and an elastic element.

13. The hydration system as claimed in claim 10, comprising an end piece, wherein the movable flap having an elastic element disposed in the second end of the arm of the conveying means.
